(19) United States
(12) Patent Application Publication
(10) Pub. No.: US 2023/0053242 A1
(43) Pub. Date: Feb. 16, 2023

(54) SYSTEM AND METHODS FOR SIMULTANEOUS RESOURCE EVALUATION AND VALIDATION TO AVOID DOWNSTREAM TAMPERING

(71) Applicant: BANK OF AMERICA CORPORATION, Charlotte, NC (US)

(72) Inventors: Adam Nathaniel Desautels, Charlotte, NC (US); Terri Smith Wright, Mooresville, NC (US); Ashok Kandukuri, Charlotte, NC (US); Ramya Ramani Satheeshkumar, Hockessin, DE (US); Catherine Ellen Donze, Phoenix, AZ (US); Michael Shih, Cherry Hill, NJ (US)

(73) Assignee: BANK OF AMERICA CORPORATION, Charlotte, NC (US)

(21) Appl. No.: 17/403,392

(22) Filed: Aug. 16, 2021

(51) Int. Cl. G06Q 20/40; G06Q 20/42; G06Q 40/02; G06Q 20/38; G06Q 20/10

(52) U.S. Cl. CPC G06Q 20/409; G06Q 20/42; G06Q 40/02; G06Q 20/4014; G06Q 20/3821; G06Q 20/108

(57) ABSTRACT

Systems, methods, and computer program products are provided for validating a deposit request. The method includes receiving a deposit request from a user device. The deposit request includes a deposit transaction information relating to an intended deposit. The method also includes determining a deposit transaction confidence level based on the deposit transaction information. The deposit transaction confidence level indicates a likelihood of the intended deposit being perfected. The method further includes causing a transmission of an audit request to the user device relating to the deposit request upon determining the deposit transaction confidence level is below a confidence level threshold. The audit request includes a request to confirm one or more details relating to the deposit request. The method still further includes determining a deposit determination based on a response to the audit response. The deposit determination indicates whether the intended deposit will be executed.

### TECHNOLOGICAL FIELD

An example embodiment relates generally to validating deposit requests, and more particularly, to providing near real-time deposit request validation.

### BACKGROUND

Deposit requests need to be processed quickly in order for the customer to access the deposited funds. However, often the execution of the deposit is complete before the deposit request (e.g., a check) is verified. Current processes sacrifice either speed or security. As such, there exists a need for a system that can validated a deposit request more quickly.

### BRIEF SUMMARY

The following presents a summary of certain embodiments of the disclosure. This summary is not intended to identify key or critical elements of all embodiments nor delineate the scope of any or all embodiments. Its sole purpose is to present certain concepts and elements of one or more embodiments in a summary form as a prelude to the more detailed description that follows.

In an example embodiment, a system for validating a deposit request is provided. The system includes at least one non-transitory storage device and at least one processing device coupled to the at least one non-transitory storage device. The at least one processing device is configured to receive a deposit request from a user device, wherein the deposit request includes a deposit transaction information relating to an intended deposit. The at least one processing device is also configured to determine a deposit transaction confidence level based on the deposit transaction information. The deposit transaction confidence level indicates a likelihood of the intended deposit being perfected and the deposit transaction confidence level is based on at least one of deposit account history or deposit request characteristics. The at least one processing device is further configured to cause a transmission of an audit request to the user device relating to the deposit request upon determining the deposit transaction confidence level is below a confidence level threshold. The audit request includes a request to confirm one or more details relating to the deposit request. The at least one processing device is still further configured to determine a deposit determination based on a response to the audit request. The deposit determination indicates whether the intended deposit will be executed.

In some embodiments, the user device is an automated teller machine (ATM) or a mobile device. In some embodiments, the deposit request includes information relating to a check to be deposited. In some embodiments, the deposit request includes a photograph or copy of the check and at least one check detail provided by the user. In such an embodiment, the deposit transaction confidence level is based at least partially on a comparison of the photograph or copy of the check with the at least one check detail provided by the user.

In some embodiments, the at least one processing device is also configured to adjust the intended deposit based on the response to the audit request. In some embodiments, the deposit determination is determined within a determination period of less than 30 seconds. In such an embodiment, the determination period is defined from the reception of the deposit request and the determination of the deposit determination.

In some embodiments, the deposit determination is a deposit rejection in an instance in which the deposit transaction confidence level remains below the confidence level threshold after receiving the response to the audit request.

In another example embodiment, a computer program product for validating a deposit request is provided. The computer program product includes at least one non-transitory computer-readable medium having computer-readable program code portions embodied therein. The computer-readable program code portions include an executable portion configured to receive a deposit request from a user device. The deposit request includes a deposit transaction information relating to an intended deposit. The computer-readable program code portions also include an executable portion configured to determine a deposit transaction confidence level based on the deposit transaction information. The deposit transaction confidence level indicates a likelihood of the intended deposit being perfected. The deposit transaction confidence level is based on at least one of deposit account history or deposit request characteristics. The computer-readable program code portions further include an executable portion configured to cause a transmission of an audit request to the user device relating to the deposit request upon determining the deposit transaction confidence level is below a confidence level threshold. The audit request includes a request to confirm one or more details relating to the deposit request. The computer-readable program code portions still further include an executable portion configured to determine a deposit determination based on a response to the audit request. The deposit determination indicates whether the intended deposit will be executed.

In some embodiments, the user device is an automated teller machine (ATM) or a mobile device. In some embodiments, the deposit request includes information relating to a check to be deposited. In some embodiments, the deposit request includes a photograph or copy of the check and at least one check detail provided by the user. In such an embodiment, the deposit transaction confidence level is based at least partially on a comparison of the photograph or copy of the check with the at least one check detail provided by the user.

In some embodiments, the computer-readable program code portions include an executable portion configured to adjust the intended deposit based on the response to the audit request. In some embodiments, the deposit determination is determined within a determination period of less than 30 seconds. In such an embodiment, the determination period is defined from the reception of the deposit request and the determination of the deposit determination.

In some embodiments, the deposit determination is a deposit rejection in an instance in which the deposit transaction confidence level remains below the confidence level threshold after receiving the response to the audit request.

In still another example embodiment, a computer-implemented method for validating a deposit request is provided. The method includes receiving a deposit request from a user device. The deposit request includes a deposit transaction information relating to an intended deposit. The method also includes determining a deposit transaction confidence level based on the deposit transaction information. The deposit transaction confidence level indicates a likelihood of the intended deposit being perfected and the deposit transaction confidence level is based on at least one of deposit account history or deposit request characteristics. The method further includes causing a transmission of an audit request to the user device relating to the deposit request upon determining the deposit transaction confidence level is below a confidence level threshold. The audit request includes a request to confirm one or more details relating to the deposit request. The method still further includes determining a deposit determination based on a response to the audit request. The deposit determination indicates whether the intended deposit will be executed.

In some embodiments, the deposit request includes information relating to a check to be deposited. In some embodiments, the deposit request includes a photograph or copy of the check and at least one check detail provided by the user. In such an embodiment, the deposit transaction confidence level is based at least partially on a comparison of the photograph or copy of the check with the at least one check detail provided by the user.

In some embodiments, the method also includes adjusting the intended deposit based on the response to the audit request. In some embodiments, the deposit determination is determined within a determination period of less than 30 seconds. In such an embodiment, the determination period is defined from the reception of the deposit request and the determination of the deposit determination.

In some embodiments, the deposit determination is a deposit rejection in an instance in which the deposit transaction confidence level remains below the confidence level threshold after receiving the response to the audit request.

Embodiments of the present disclosure address the above needs and/or achieve other advantages by providing apparatuses (e.g., a system, computer program product and/or other devices) and methods for dynamically generating optimized data queries to improve hardware efficiency and utilization. The system embodiments may comprise one or more memory devices having computer readable program code stored thereon, a communication device, and one or more processing devices operatively coupled to the one or more memory devices, wherein the one or more processing devices are configured to execute the computer readable program code to carry out said embodiments. In computer program product embodiments of the disclosure, the computer program product comprises at least one non-transitory computer readable medium comprising computer readable instructions for carrying out said embodiments. Computer implemented method embodiments of the disclosure may comprise providing a computing system comprising a computer processing device and a non-transitory computer readable medium, where the computer readable medium comprises configured computer program instruction code, such that when said instruction code is operated by said computer processing device, said computer processing device performs certain operations to carry out said embodiments.

### BRIEF DESCRIPTION OF THE DRAWINGS

Having thus described embodiments of the disclosure in general terms, reference will now be made the accompanying drawings, wherein:

FIG. 1 provides a block diagram illustrating a system environment for deposit request validation, in accordance with embodiments of the present disclosure;

FIG. 2 provides a block diagram illustrating the entity system 200 of FIG. 1, in accordance with embodiments of the present disclosure;

FIG. 3 provides a block diagram illustrating a deposit request verification device 300 of FIG. 1, in accordance with embodiments of the present disclosure;

FIG. 4 provides a block diagram illustrating the computing device system 400 of FIG. 1, in accordance with embodiments of the present disclosure; and

FIG. 5 provides a flowchart illustrating a method of validating a deposit request in accordance with embodiments of the present disclosure.

### DETAILED DESCRIPTION

Embodiments of the present disclosure will now be described more fully hereinafter with reference to the accompanying drawings, in which some, but not all, embodiments of the present disclosure are shown. Indeed, the present disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As described herein, the term “entity” may be any organization that utilizes one or more entity resources, including, but not limited to, one or more entity systems, one or more entity databases, one or more applications, one or more servers, or the like to perform one or more organization activities associated with the entity. In some embodiments, an entity may be any organization that develops, maintains, utilizes, and/or controls one or more applications and/or databases. Applications as described herein may be any software applications configured to perform one or more operations of the entity. Databases as described herein may be any datastores that store data associated with organizational activities associated with the entity. In some embodiments, the entity may be a financial institution which may include herein may include any financial institutions such as commercial banks, thrifts, federal and state savings banks, savings and loan associations, credit unions, investment companies, insurance companies and the like. In some embodiments, the financial institution may allow a customer to establish an account with the financial institution. In some embodiments, the entity may be a non-financial institution.

Many of the example embodiments and implementations described herein contemplate interactions engaged in by a user with a computing device and/or one or more communication devices and/or secondary communication devices. A “user”, as referenced herein, may refer to an entity or individual that has the ability and/or authorization to access and use one or more applications provided by the entity and/or the system of the present disclosure. Furthermore, as used herein, the term “user computing device” or “mobile device” may refer to mobile phones, computing devices, tablet computers, wearable devices, smart devices and/or any portable electronic device capable of receiving and/or storing data therein.

A “user interface” is any device or software that allows a user to input information, such as commands or data, into a device, or that allows the device to output information to the user. For example, the user interface includes a graphical user interface (GUI) or an interface to input computer-executable instructions that direct a processing device to carry out specific functions. The user interface typically employs certain input and output devices to input data received from a user or to output data to a user. These input and output devices may include a display, mouse, keyboard, button, touchpad, touch screen, microphone, speaker, LED, light, joystick, switch, buzzer, bell, and/or other user input/output device for communicating with one or more users.

As used herein, “machine learning algorithms” may refer to programs (math and logic) that are configured to self-adjust and perform better as they are exposed to more data. To this extent, machine learning algorithms are capable of adjusting their own parameters, given feedback on previous performance in making prediction about a dataset. Machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable form of machine learning algorithm.

As used herein, “machine learning model” may refer to a mathematical model generated by machine learning algorithms based on sample data, known as training data, to make predictions or decisions without being explicitly programmed to do so. The machine learning model represents what was learned by the machine learning algorithm and represents the rules, numbers, and any other algorithm-specific data structures required to for classification.

Conventional systems that detect deposit malfeasance traditionally either allow the deposit to be executed or the funds will be placed on HOLD when potential malfeasance is detected. The HOLD traditionally takes a given amount of time to determine whether the deposit request is valid. However, these HOLDs cannot be indefinite and often result in dissatisfaction from customers.

The present disclosure allows for quicker malfeasance detection and determination by allowing for near-real-time deposit validation. In an example, the validation process is carried out in parallel with the actual processing of the deposit. As such, the validation is completed ahead of the perfection of the deposit, reducing the amount of malfeasant deposits being perfected. The malfeasance detection discussed herein allows for interaction with the user and ultimately, in an instance in which the deposit is rejected, the deposit request can be returned to the user with the rejection (e.g., a customer attempting to deposit a check at an ATM may have the check returned to said customer during the same transaction).

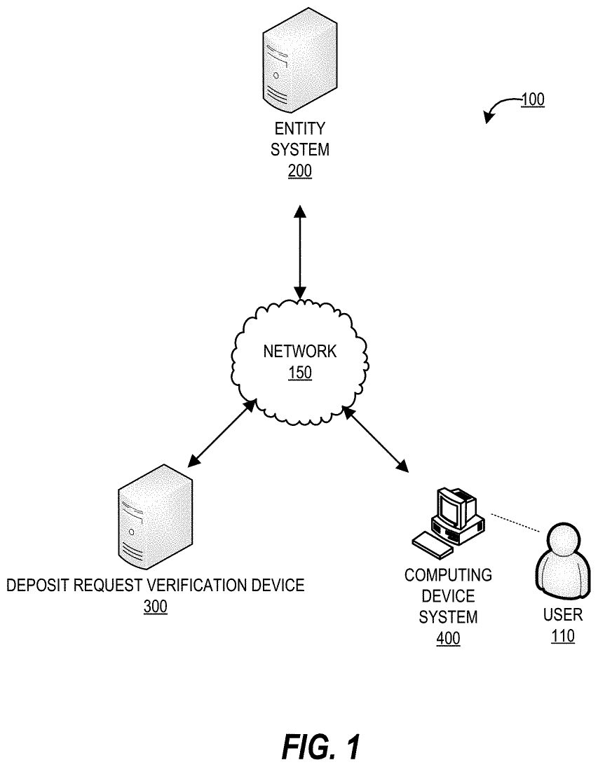

FIG. 1 provides a block diagram illustrating a system environment 100 for dynamically generating optimized data queries to improve hardware efficiency and utilization, in accordance with an embodiment of the present disclosure. As illustrated in FIG. 1, the environment 100 includes a deposit request verification device 300, an entity system 200, and a computing device system 400. One or more users 110 may be included in the system environment 100, where the users 110 interact with the other entities of the system environment 100 via a user interface of the computing device system 400. In some embodiments, the one or more user(s) 110 of the system environment 100 may be employees (e.g., application developers, database administrators, application owners, application end users, business analysts, finance agents, or the like) of an entity associated with the entity system 200.

The entity system(s) 200 may be any system owned or otherwise controlled by an entity to support or perform one or more process steps described herein. In some embodiments, the entity is a financial institution. In some embodiments, the entity may be a non-financial institution. In some embodiments, the entity may be any organization that utilizes one or more entity resources to perform one or more organizational activities.

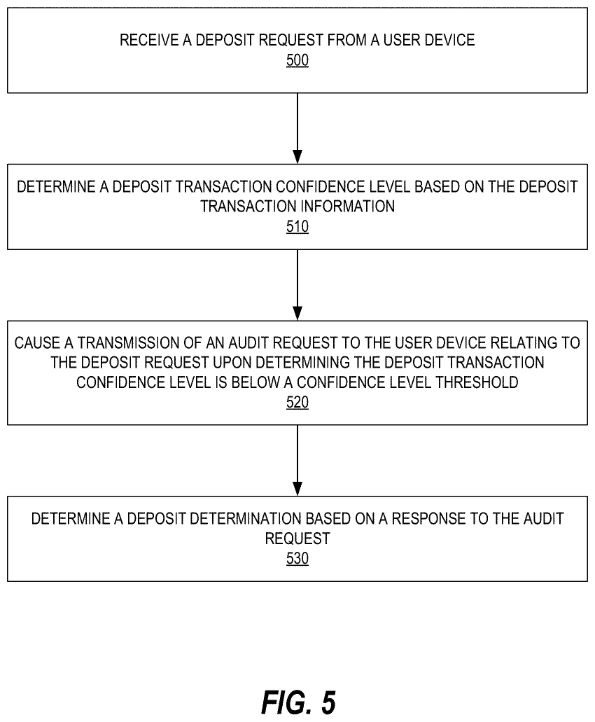

The deposit request verification device 300 is a system of the present disclosure for performing one or more process steps described herein. In some embodiments, the deposit request verification device 300 may be an independent system. In some embodiments, the deposit request verification device 300 may be a part of the entity system 200. For example, the method of FIG. 5 may be carried out by the entity system 200, the deposit request verification device 300, the computing device system 400, and/or a combination thereof.

The deposit request verification device 300, the entity system 200, and the computing device system 400 may be in network communication across the system environment 100 through the network 150. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet. In general, the deposit request verification device 300 is configured to communicate information or instructions with the entity system 200, and/or the computing device system 400 across the network 150. While the entity system 200, the deposit request verification device 300, and the computing device system 400 are illustrated as separate components communicating via network 150, one or more of the components discussed here may be carried out via the same system (e.g., a single system may include the entity system 200 and the deposit request verification device 300).

The computing device system 400 may be a system owned or controlled by the entity of the entity system 200 and/or the user 110. As such, the computing device system 400 may be a computing device of the user 110. In general, the computing device system 400 communicates with the user 110 via a user interface of the computing device system 400, and in turn is configured to communicate information or instructions with the deposit request verification device 300, and/or entity system 200 across the network 150.

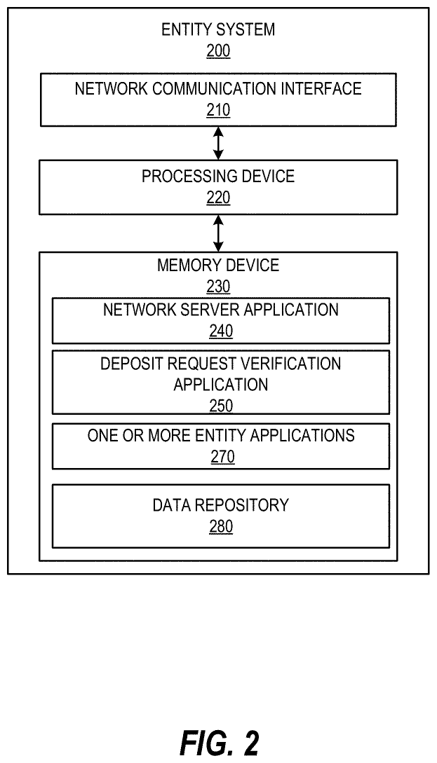

FIG. 2 provides a block diagram illustrating the entity system 200, in greater detail, in accordance with embodiments of the disclosure. As illustrated in FIG. 2, in one embodiment, the entity system 200 includes one or more processing devices 220 operatively coupled to a network communication interface 210 and a memory device 230. In certain embodiments, the entity system 200 is operated by a first entity, such as a financial institution. In some embodiments, the entity system 200 may be a multi-tenant cluster storage system.

It should be understood that the memory device 230 may include one or more databases or other data structures/repositories. The memory device 230 also includes computer-executable program code that instructs the processing device 220 to operate the network communication interface 210 to perform certain communication functions of the entity system 200 described herein. For example, in one embodiment of the entity system 200, the memory device 230 includes, but is not limited to, a deposit request verification application 250, one or more entity applications 270, and a data repository 280 comprising data accessed, retrieved, and/or computed by the entity system 200. The one or more entity applications 270 may be any applications developed, supported, maintained, utilized, and/or controlled by the entity. The computer-executable program code of the network server application 240, the deposit request verification application 250, the one or more entity application 270 to perform certain logic, data-extraction, and data-storing functions of the entity system 200 described herein, as well as communication functions of the entity system 200.

The network server application 240, the deposit request verification application 250, and the one or more entity applications 270 are configured to store data in the data repository 280 or to use the data stored in the data repository 280 when communicating through the network communication interface 210 with the deposit request verification device 300, and/or the computing device system 400 to perform one or more process steps described herein. In some embodiments, the entity system 200 may receive instructions from the deposit request verification device 300 via the deposit request verification application 250 to perform certain operations. The deposit request verification application 250 may be provided by the deposit request verification device 300. The one or more entity applications 270 may be any of the applications used, created, modified, facilitated, and/or managed by the entity system 200.

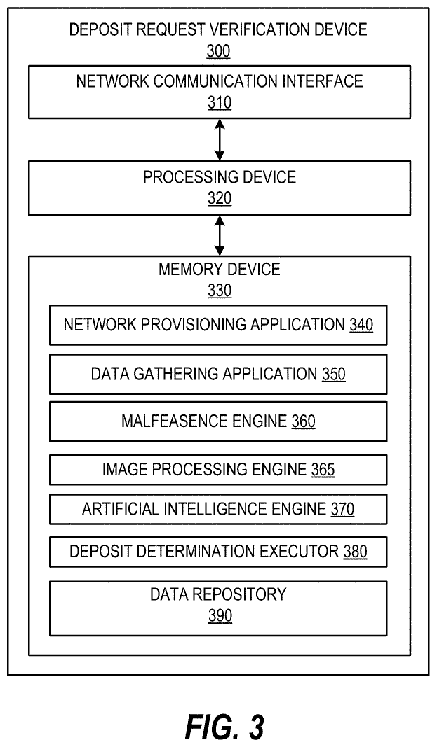

FIG. 3 provides a block diagram illustrating the deposit request verification device 300 in greater detail, in accordance with various embodiments. As illustrated in FIG. 3, in one embodiment, the deposit request verification device 300 includes one or more processing devices 320 operatively coupled to a network communication interface 310 and a memory device 330. In certain embodiments, the deposit request verification device 300 is operated by an entity, such as a financial institution. In some embodiments, the deposit request verification device 300 is owned or operated by the entity of the entity system 200. In some embodiments, the deposit request verification device 300 may be an independent system. In alternate embodiments, the deposit request verification device 300 may be a part of the entity system 200.

It should be understood that the memory device 330 may include one or more databases or other data structures/repositories. The memory device 330 also includes computer-executable program code that instructs the processing device 320 to operate the network communication interface 310 to perform certain communication functions of the deposit request verification device 300 described herein. For example, in one embodiment of the deposit request verification device 300, the memory device 330 includes, but is not limited to, a network provisioning application 340, a data gathering application 350, a malfeasance engine 360, an image processing engine 365, an artificial intelligence engine 370, a deposit determination executor 380, and a data repository 390 comprising any data processed or accessed by one or more applications in the memory device 330. The computer-executable program code of the network provisioning application 340, the data gathering application 350, the malfeasance engine 360, the image processing engine 365, the artificial intelligence engine 370, and the deposit determination executor 380 may instruct the processing device 320 to perform certain logic, data-processing, and data-storing functions of the deposit request verification device 300 described herein, as well as communication functions of the deposit request verification device 300.

The network provisioning application 340, the data gathering application 350, the malfeasance engine 360, the image processing engine 365, the artificial intelligence engine 370, and the deposit determination executor 380 are configured to invoke or use the data in the data repository 390 when communicating through the network communication interface 310 with the entity system 200, and/or the computing device system 400. In some embodiments, the network provisioning application 340, the data gathering application 350, the malfeasance engine 360, the image processing engine 365, the artificial intelligence engine 370, and the deposit determination executor 380 may store the data extracted or received from the entity system 200, and the computing device system 400 in the data repository 390. In some embodiments, the network provisioning application 340, the data gathering application 350, the malfeasance engine 360, the image processing engine 365, the artificial intelligence engine 370, and the deposit determination executor 380 may be a part of a single application.

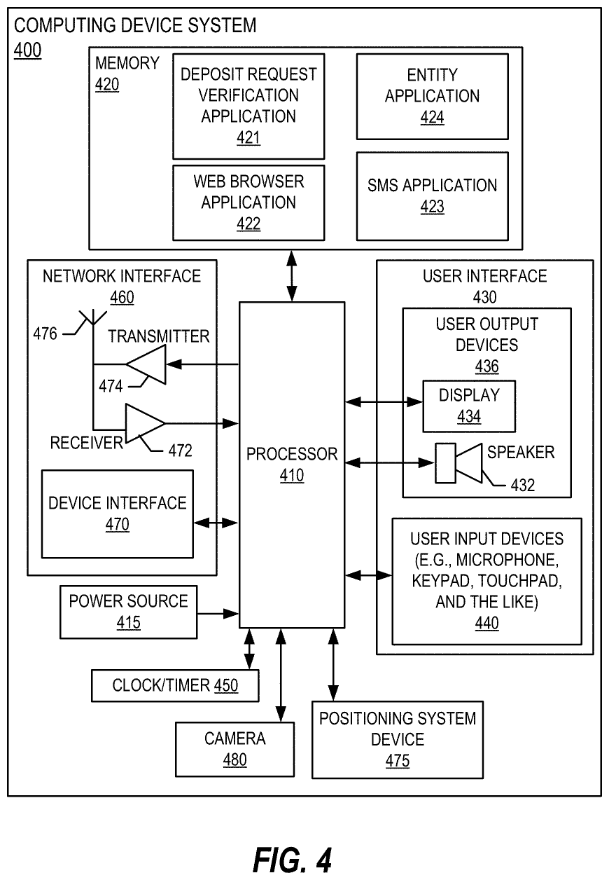

FIG. 4 provides a block diagram illustrating a computing device system 400 of FIG. 1 in more detail, in accordance with various embodiments. However, it should be understood that a mobile telephone is merely illustrative of one type of computing device system 400 that may benefit from, employ, or otherwise be involved with embodiments of the present disclosure and, therefore, should not be taken to limit the scope of embodiments of the present disclosure. Other types of computing devices may include portable digital assistants (PDAs), pagers, mobile televisions, gaming devices, desktop computers, workstations, laptop computers, cameras, video recorders, audio/video player, radio, GPS devices, wearable devices, Internet-of-things devices, augmented reality devices, virtual reality devices, automated teller machine (ATM) devices, electronic kiosk devices, or any combination of the aforementioned.

Some embodiments of the computing device system 400 include a processor 410 communicably coupled to such devices as a memory 420, user output devices 436, user input devices 440, a network interface 460, a power source 415, a clock or other timer 450, a camera 480, and a positioning system device 475. The processor 410, and other processors described herein, generally include circuitry for implementing communication and/or logic functions of the computing device system 400. For example, the processor 410 may include a digital signal processor device, a microprocessor device, and various analog to digital converters, digital to analog converters, and/or other support circuits. Control and signal processing functions of the computing device system 400 are allocated between these devices according to their respective capabilities. The processor 410 thus may also include the functionality to encode and interleave messages and data prior to modulation and transmission. The processor 410 can additionally include an internal data modem. Further, the processor 410 may include functionality to operate one or more software programs, which may be stored in the memory 420. For example, the processor 410 may be capable of operating a connectivity program, such as a web browser application 422. The web browser application 422 may then allow the computing device system 400 to transmit and receive web content, such as, for example, location-based content and/or other web page content, according to a Wireless Application Protocol (WAP), Hypertext Transfer Protocol (HTTP), and/or the like.

The processor 410 is configured to use the network interface 460 to communicate with one or more other devices on the network 150. In this regard, the network interface 460 includes an antenna 476 operatively coupled to a transmitter 474 and a receiver 472 (together a “transceiver”). The processor 410 is configured to provide signals to and receive signals from the transmitter 474 and receiver 472, respectively. The signals may include signaling information in accordance with the air interface standard of the applicable cellular system of the wireless network 152. In this regard, the computing device system 400 may be configured to operate with one or more air interface standards, communication protocols, modulation types, and access types. By way of illustration, the computing device system 400 may be configured to operate in accordance with any of a number of first, second, third, and/or fourth-generation communication protocols and/or the like.

As described above, the computing device system 400 has a user interface that is, like other user interfaces described herein, made up of user output devices 436 and/or user input devices 440. The user output devices 436 include a display 430 (e.g., a liquid crystal display or the like) and a speaker 432 or other audio device, which are operatively coupled to the processor 410.

The user input devices 440, which allow the computing device system 400 to receive data from a user such as the user 110, may include any of a number of devices allowing the computing device system 400 to receive data from the user 110, such as a keypad, keyboard, touch-screen, touchpad, microphone, mouse, joystick, other pointer device, button, soft key, and/or other input device(s). The user interface may also include a camera 480, such as a digital camera.

The computing device system 400 may also include a positioning system device 475 that is configured to be used by a positioning system to determine a location of the computing device system 400. For example, the positioning system device 475 may include a GPS transceiver. In some embodiments, the positioning system device 475 is at least partially made up of the antenna 476, transmitter 474, and receiver 472 described above. For example, in one embodiment, triangulation of cellular signals may be used to identify the approximate or exact geographical location of the computing device system 400. In other embodiments, the positioning system device 475 includes a proximity sensor or transmitter, such as an RFID tag, that can sense or be sensed by devices known to be located proximate a merchant or other location to determine that the computing device system 400 is located proximate these known devices.

The computing device system 400 further includes a power source 415, such as a battery, for powering various circuits and other devices that are used to operate the computing device system 400. Embodiments of the computing device system 400 may also include a clock or other timer 450 configured to determine and, in some cases, communicate actual or relative time to the processor 410 or one or more other devices.

The computing device system 400 also includes a memory 420 operatively coupled to the processor 410. As used herein, memory includes any computer readable medium (as defined herein below) configured to store data, code, or other information. The memory 420 may include volatile memory, such as volatile Random Access Memory (RAM) including a cache area for the temporary storage of data. The memory 420 may also include non-volatile memory, which can be embedded and/or may be removable. The non-volatile memory can additionally or alternatively include an electrically erasable programmable read-only memory (EEPROM), flash memory or the like.

The memory 420 can store any of a number of applications which comprise computer-executable instructions/code executed by the processor 410 to implement the functions of the computing device system 400 and/or one or more of the process/method steps described herein. For example, the memory 420 may include such applications as a conventional web browser application 422, a deposit request verification application 421, entity application 424. These applications also typically instructions to a graphical user interface (GUI) on the display 430 that allows the user 110 to interact with the entity system 200, the deposit request verification device 300, and/or other devices or systems. The memory 420 of the computing device system 400 may comprise a Short Message Service (SMS) application 423 configured to send, receive, and store data, information, communications, alerts, and the like via the wireless telephone network 152. In some embodiments, the deposit request verification application 421 provided by the deposit request verification device 300 allows the user 110 to access the deposit request verification device 300. In some embodiments, the entity application 424 provided by the entity system 200 and the deposit request verification application 421 allow the user 110 to access the functionalities provided by the deposit request verification device 300 and the entity system 200.

The memory 420 can also store any of a number of pieces of information, and data, used by the computing device system 400 and the applications and devices that make up the computing device system 400 or are in communication with the computing device system 400 to implement the functions of the computing device system 400 and/or the other systems described herein.

Referring now to FIG. 5, a method of validating a deposit request is provided. The method may be carried out by a system discussed herein (e.g., the entity system 200, the deposit request verification device 300, and/or the computing device system 400). An example system may include at least one non-transitory storage device and at least one processing device coupled to the at least one non-transitory storage device. In such an embodiment, the at least one processing device is configured to carry out the method discussed herein.

Referring now to Block 500 of FIG. 5, the method includes receiving a deposit request from a user device (e.g., computing device system 400). The deposit request includes deposit transaction information relating to an intended deposit. The deposit transaction information includes one or more features of the deposit to allow for the deposit to be executed. The deposit transaction information may include payer account information (e.g., account number and/or routing number), payee account information (e.g., account number and/or routing number), specifics of the intended deposit (deposit amount, details on check), and/or the like.

In various embodiments, the user device is an automated teller machine (ATM) or a mobile device. The deposit request may be associated with a user and/or user account (e.g., the funds being deposited may be deposited into a given user account). A user providing a deposit request may have a user account that is associated with said user. The user may access said user account associated with the user on the user device via one or more account security measures. For example, the user may use a debit card and/or pin number to access the said user account on the ATM. In another example, the user may have a username and password to access said user account via a mobile device (e.g., on a mobile application). In various embodiments, information to identify the intended user (e.g., the payee) account may be provided along with the deposit request (e.g., the user account number may be provided with the deposit request).

In various embodiments, the deposit request includes information relating to a check to be deposited. The deposit request can include a photograph or copy of the check provided via the user device (e.g., computing device system 400). In an instance in which the user device is a mobile device, a user may provide a photo of the check to be deposited (e.g., via taking a photograph of the check using the camera 480 shown in FIG. 4). In an instance in which the user device is an ATM, a user may provide the check to the ATM for processing. For example, the check may be received by the ATM and subsequently copied by the ATM and provided to the network 150 for the processing discussed herein. The ATM may be equipped with a camera 480, just as the mobile device discussed above.

The check image may be processed via one or more machine learning models. For example, the check image may be processed using optical character recognition (OCR) or other image processing techniques. Additionally, the system may include one or more machine learning models used to process the images and then update based on the operations herein. The deposit transaction information can be obtained from the check image via said image processing. Deposit transaction information can include payer routing number, payer account number, payer identity information, deposit amount, payer identity information, date of check execution, and/or the like.

Deposit transaction information obtained from processing the check image may also be verified by the user. For example, the user may provide one or more check details relating to the deposit request. The user provided check details may be independent of and/or in conjunction with the check image processing. For example, the system may request a user indicate the deposit amount. Additionally or alternatively, the system may request the user confirm the deposit amount determined via the image processing (e.g., the user may receive a prompt on the user device to confirm the amount of a check to be deposited). The check details provided by the user may be used in conjunction with the image processing of the check to determine the confidence level discussed below. The one or more check details provided by the user may include deposit amount, deposit account, account information for check (payer information), depositing account information (e.g., user may select account in which to deposit), date of check execution, and/or the like. The check details may be commonly detected details, such as deposit amount. In some embodiments, at least one of the one or more check details may be required to submit the deposit request (e.g., the user must enter the amount of the check). Additionally or alternatively, one or more of the check details may be optional (e.g., the user may be able to input information from the check, but is not required to do so in order for the deposit request to be reviewed). In various embodiments, the more check details provided by a user, the more accurate the resulting deposit transaction confidence level may be for the deposit request.

Referring now to Block 510 of FIG. 5, the method includes determining a deposit transaction confidence level based on the deposit transaction information. The deposit transaction confidence level indicates a likelihood of the intended deposit being perfected. The deposit transaction confidence level can be based on depositing account (payee) history, payer account history, deposit request characteristics (e.g., deposit transaction information), and/or the like. For example, the history of known malfeasance by the payee account or the payer account may decrease the deposit transaction confidence level. Additionally or alternatively, the characteristics of the specific deposit request may be used to determine the deposit transaction confidence level (e.g., the check being deposited may be inaccurate or incomplete).

In some embodiments, the deposit transaction confidence level is based at least partially on a comparison of the copy of the check and the at least one check detail provided by the user. As discussed above, the check image may be processed (e.g., via OCR or the like) and then the deposit transaction information obtained via the processed check image may be compared to one or more check details provided by the user. Such a comparison affects the deposit transaction confidence level. For example, the deposit transaction confidence level may be higher in an instance in which the deposit amount determined via the check image processing matches the deposit amount entered by the user.

In some embodiments, the deposit transaction confidence level can be a numerical value (e.g., a number between 0 and 100) with the higher number being more confidence in the validity of the deposit request. The deposit transaction confidence level can be based on the amount of information received, as well as the amount of information not known about a given deposit request. For example, the deposit transaction confidence level may be lower for transaction involving a payer that has little to no transaction history or banks with an institution that does not makes information relating to the payer readily available.

The deposit transaction confidence level can be used to determine whether to proceed with processing the deposit request to perfection. In an example embodiment, a confidence level threshold may be set to indicate a specific confidence level required to proceed with executing the deposit. In an instance in which the deposit transaction confidence level is at least the same or higher than the confidence level threshold, then a transmission may be caused to proceed with executing the intended deposit. In an instance in which the deposit transaction confidence level is below the confidence level threshold, the steps of Block 520 through Block 530 may be carried out as discussed herein. In some embodiments, the system may have a lower confidence level bound under which the deposit request is rejected without carrying out the validation steps of Block 520 through Block 530 (e.g., instead of presenting the user device with an audit request, the user device would receive a rejection notification).

The confidence level threshold may be consistent across any transaction (e.g., same level of security for any transaction). Alternatively, the confidence level threshold may be different based on the transaction type. For example, the confidence level threshold may be higher for a transaction involving a certain value threshold (e.g., the confidence level threshold may be higher in an instance a deposit request is for $10,000 than the confidence level threshold is in an instance in which the deposit request is for $100).

Referring now to Block 520 of FIG. 5, the method includes causing a transmission of an audit request to the user device relating to the deposit request upon determining the deposit transaction confidence level is below a confidence level threshold.

The audit request may be generated based on the analysis of the deposit request. The audit request is a request for one or more details relating to the deposit request. The audit request can be a request to confirm one or more details relating to the deposit request (e.g., an audit request may be for the user to confirm the deposit amount). Additionally or alternatively, the audit request may be a request for additional check details relating to the deposit request. The additional check details requested may be to clarify deposit transaction information that was unclear based on the initial deposit transaction information. For example, in an instance in which information on a check is obscured in the check image, the audit request may request the user to update said obscured information. In an example embodiment, an audit request may include requesting an additional image of the check being deposited (e.g., the original check image may be obscured, and the audit request may request a new image).

The audit request may be provided to the user via the user device (e.g., the computing device system 400). The audit request may be provided to the user during the same user session as the initial deposit request. Additionally or alternatively, the audit request may be provided outside of the same user session (e.g., email or other type of messaging).

Based on the response to the audit request, the deposit transaction confidence level may be updated. For example, in an instance in which the response confirmed deposit transaction information as accurate, the deposit transaction confidence level may be increased. In another example, the response to the audit request may clarify inaccuracies in the initial deposit request causing the deposit transaction confidence level to increase. The response to the audit request may provide additional information from which the system can determine the deposit transaction confidence level (e.g., the user may provide additional identity confirmations). In some instances, the response to the audit response (or absence of a response to audit response) can cause the deposit transaction confidence level to decrease. For example, if the response to audit request provides information that is contradictory to the deposit transaction information, the deposit transaction confidence level may decrease.

The intended deposit may also be adjusted based on the response to the audit request. The response to the audit response may indicate that the initial deposit request was incorrect or processed incorrectly (e.g., the image processing resulted in inaccurate results and the response to the audit request corrected such inaccuracy). The updated intended deposit may result in a different deposit transaction confidence level based on the other information provided with the deposit request. For example, the deposit transaction confidence level could be higher for the updated intended deposit in an instance the response to the audit request provided clarifying information causing the adjustment to the intended deposit.

Referring now to Block 530 of FIG. 5, the method includes determining a deposit determination based on a response to the audit request. The deposit determination indicates whether the intended deposit will be executed. The determination of the deposit determination is based on the updated deposit transaction confidence level in response to the response to the audit request. The updated deposit transaction confidence level may be compared to the confidence level threshold to determine the deposit determination.

In an instance in which the updated deposit transaction confidence level is the same or above the confidence level threshold, the deposit determination will be to proceed with executing the intended deposit. As such, the perfection of the intended deposit would proceed.

In an instance in which the intended deposit is adjusted due to the response to the audit request, if the new deposit transaction confidence level is the same or above the confidence level threshold, the deposit determination will be to proceed with executing the adjusted intended deposit.

In an instance in which the deposit transaction confidence level remains below the confidence level threshold, the deposit determination will be to reject the deposit request. The rejected deposit request may be returned to the user device (e.g., the check may be returned to the user at an ATM or the user may receive an error message on a mobile device). The deposit rejection may include one or more indicators that caused the deposit request to be rejection. For example, a notification may be provided to the user that the amount indicated on the check did not match the amount indicated by the user.

The deposit determination is determined within a determination period. The determination period is defined from the reception of the deposit request and the determination of the deposit determination. The determination period is less than a traditional verification process can be completed (e.g., allowing the steps discussed herein to be carried out in parallel with the perfection of the deposit request instead of subsequent to said perfection). The determination period may be less than the time of a user account login session (e.g., the deposit determination may be returned to the user via the user device during the same user session as the deposit request). In an example embodiment, the determination period is less than 30 seconds.

As will be appreciated by one of skill in the art, the present disclosure may be embodied as a method (including, for example, a computer-implemented process, a business process, and/or any other process), apparatus (including, for example, a system, machine, device, computer program product, and/or the like), or a combination of the foregoing. Accordingly, embodiments of the present disclosure may take the form of an entirely hardware embodiment, an entirely software embodiment (including firmware, resident software, micro-code, and the like), or an embodiment combining software and hardware aspects that may generally be referred to herein as a “system.” Furthermore, embodiments of the present disclosure may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present disclosure may be written in an object oriented, scripted or unscripted programming language such as Java, Perl, Smalltalk, C++, or the like. However, the computer program code for carrying out operations of embodiments of the present disclosure may also be written in conventional procedural programming languages, such as the “C” programming language or similar programming languages.

Embodiments of the present disclosure are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the disclosure.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present disclosure are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad disclosure, and that this disclosure not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the disclosure. Therefore, it is to be understood that, within the scope of the appended claims, the disclosure may be practiced other than as specifically described herein.

1. A system for validating a deposit request, the system comprising:
at least one non-transitory storage device; and
at least one processing device coupled to the at least one non-transitory storage device, wherein the at least one processing device is configured to:
receive a deposit request from a user device, wherein the deposit request includes a deposit transaction information relating to an intended deposit, wherein the deposit request includes information relating to a check to be deposited, wherein the deposit request includes a photograph or copy of the check and at least one check detail provided by a user via the user device;
obtain deposit transaction information from the photograph or copy of the check using optical character recognition and from the at least one check detail provided by the user via the user device;
based on the deposit transaction information, determine a deposit transaction confidence level, wherein the deposit transaction confidence level indicates a likelihood of the intended deposit being perfected, wherein the deposit transaction confidence level is based on at least one of deposit account history or deposit request characteristics, wherein the deposit transaction confidence level is based at least partially on a comparison of the photograph or copy of the check with the at least one check detail provided by the user;
upon determining the deposit transaction confidence level is below a confidence level threshold, cause a transmission of an audit request to the user device relating to the deposit request, wherein the audit request comprises a request to confirm one or more details relating to the deposit request;
based on a response to the audit request, determine a deposit determination, wherein the deposit determination indicates whether the intended deposit will be executed.

2. The system of claim 1, wherein the user device is an automated teller machine (ATM) or a mobile device.

3. (canceled)

4. (canceled)

5. The system of claim 1, wherein the at least one processing device is also configured to adjust the intended deposit based on the response to the audit request.

6. The system of claim 1, wherein the deposit determination is determined within a determination period of less than 30 seconds, wherein the determination period is defined from the reception of the deposit request and the determination of the deposit determination.

7. The system of claim 1, wherein the deposit determination is a deposit rejection in an instance in which the deposit transaction confidence level remains below the confidence level threshold after receiving the response to the audit request.

8. A computer program product for validating a deposit request, the computer program product comprising at least one non-transitory computer-readable medium having computer-readable program code portions embodied therein, the computer-readable program code portions comprising:
an executable portion configured to receive a deposit request from a user device, wherein the deposit request includes a deposit transaction information relating to an intended deposit wherein the deposit request includes information relating to a check to be deposited, wherein the deposit request includes a photograph or copy of the check and at least one check detail provided by a user via the user device;
an executable portion configured to obtain deposit transaction information from the photograph or copy of the check using optical character recognition and from the at least one check detail provided by the user via the user device;
an executable portion configured to determine a deposit transaction confidence level based on the deposit transaction information, wherein the deposit transaction confidence level indicates a likelihood of the intended deposit being perfected, wherein the deposit transaction confidence level is based on at least one of deposit account history or deposit request characteristics, wherein the deposit transaction confidence level is based at least partially on a comparison of the photograph or copy of the check with the at least one check detail provided by the user;
an executable portion configured to cause a transmission of an audit request to the user device relating to the deposit request upon determining the deposit transaction confidence level is below a confidence level threshold, wherein the audit request comprises a request to confirm one or more details relating to the deposit request; and
an executable portion configured to determine a deposit determination based on a response to the audit request, wherein the deposit determination indicates whether the intended deposit will be executed.

9. The computer program product of claim 8, wherein the user device is an automated teller machine (ATM) or a mobile device.

10. (canceled)

11. (canceled)

12. The computer program product of claim 8, wherein the computer-readable program code portions include an executable portion configured to adjust the intended deposit based on the response to the audit request.

13. The computer program product of claim 8, wherein the deposit determination is determined within a determination period of less than 30 seconds, wherein the determination period is defined from the reception of the deposit request and the determination of the deposit determination.

14. The computer program product of claim 8, wherein the deposit determination is a deposit rejection in an instance in which the deposit transaction confidence level remains below the confidence level threshold after receiving the response to the audit request.

15. A computer-implemented method for validating a deposit request,
the method comprising:
receiving a deposit request from a user device, wherein the deposit request includes a deposit transaction information relating to an intended deposit, wherein the deposit request includes information relating to a check to be deposited, wherein the deposit request includes a photograph or copy of the check and at least one check detail provided by a user via the user device;
obtaining deposit transaction information from the photograph or copy of the check using optical character recognition and from the at least one check detail provided by the user via the user device;
based on the deposit transaction information, determining a deposit transaction confidence level, wherein the deposit transaction confidence level indicates a likelihood of the intended deposit being perfected, wherein the deposit transaction confidence level is based on at least one of deposit account history or deposit request characteristics, wherein the deposit transaction confidence level is based at least partially on a comparison of the photograph or copy of the check with the at least one check detail provided by the user;
upon determining the deposit transaction confidence level is below a confidence level threshold, causing a transmission of an audit request to the user device relating to the deposit request, wherein the audit request comprises a request to confirm one or more details relating to the deposit request;
based on a response to the audit request, determining a deposit determination, wherein the deposit determination indicates whether the intended deposit will be executed.

16. (canceled)

17. (canceled)

18. The computer-implemented method of claim 15, further comprising adjusting the intended deposit based on the response to the audit request.

19. The computer-implemented method of claim 15, wherein the deposit determination is determined within a determination period of less than 30 seconds, wherein the determination period is defined from the reception of the deposit request and the determination of the deposit determination.

20. The computer-implemented method of claim 15, wherein the deposit determination is a deposit rejection in an instance in which the deposit transaction confidence level remains below the confidence level threshold after receiving the response to the audit request.
